(19) United States
(12) Patent Application Publication
(10) Pub. No.: US 2023/0004170 A1
(43) Pub. Date: Jan. 5, 2023

(54) MODULAR CONTROL SYSTEM AND METHOD FOR CONTROLLING AUTOMATED GUIDED VEHICLE

(71) Applicants: Delta Electronics Int'l (Singapore) Pte Ltd, Singapore (SG); Nanyang Technological University, Singapore (SG)

(72) Inventors: Chun-Lin Chen, Singapore (SG); Yongjun Wee, Singapore (SG); Maoxun Li, Singapore (SG); Lihua Xie, Singapore (SG); Po-Kai Huang, Taipei (TW); Jui-Yang Hung, Taipei (TW)

(21) Appl. No.: 17/566,102

(22) Filed: Dec. 30, 2021

Related U.S. Application Data
(60) Provisional application No. 63/217,118, filed on Jun. 30, 2021.

(51) Int. Cl. G05D 1/02; G01C 21/00; G06K 9/62; G06V 10/44; G06V 20/56

(52) U.S. Cl. CPC G05D 1/0276; G05D 1/0225; G05D 1/0274; G01C 21/3807; G05D 1/0231; G05D 1/027; G06K 9/6289; G06V 10/443; G06K 9/6201; G06V 20/56; G05D 2201/0216

(57) ABSTRACT

A modular control system for controlling an AGV includes an interface, a processor, a memory, and a plurality of programs. The plurality of programs include a task scheduling module, a sensor fusion module, a mapping module, and a localization module. The interface receives a command signal from an AGV management system and sensor signals from a plurality of sensors. The memory stores a surrounding map and the plurality of programs to be executed by the processor. The task scheduling module converts the command signal to generate an enabling signal. The sensor fusion module processes the received sensor signals according to the enabling signal and generates an organized sensor data. The mapping module processes the organized sensor data and the surrounding map to generate an updated surrounding map. The localization module processes the organized sensor data and the updated surrounding map to generate a location and pose signal.

### CROSS-REFERENCE TO RELATED APPLICATION

This application claims the benefit of U.S. Provisional Application Ser. No. 63/217,118 filed on Jun. 30, 2021, the disclosure of which is incorporated herein by reference.

### FIELD OF THE INVENTION

The present disclosure relates to a modular control system, and more particularly relates to a modular control system and method for controlling an automated guided vehicle (hereinafter “AGV”).

### BACKGROUND OF THE INVENTION

Nowadays the AGVs are playing an important role in factory/warehouse automation field and the enhancement in technology has been increasing autonomy of AGV that requires little human intervention to complete the functional task of AGV. The mature sensing and perception technology allow navigation in complex environments and the intelligent control algorithm allows AGVs to conduct the more complex missions or functional tasks.

However the AGVs have been designed to handle a variety of functional tasks such as mapping, localization, navigation, automatic mapping, docking, and safety operation, which needs high variance in size, weight, power, mobility, maximum payload, payload type, and navigation type. As such the AGVs require high degree of customization to be used in different applications. The expert input is required to customize the AGV solution according to the required mission complexity, environment difficulty and human independence. The technical problem needs to be resolved is to quickly adapt the AGV solution to be used in different applications.

Please refer to FIG. 1. FIG. 1 schematically illustrates the systematic architecture of the AGV in U.S. Pat. No. 9,476,730 B2. A generic framework for the AGV control exists but requires much customization in different applications due to the different sensing and computational hardware, software, and algorithms used. Furthermore, the conventional architecture is difficult to upgrade with new hardware, software, or algorithm introduced, and the completed development lifecycle needs to be repeated with rigorous testing. In comparison, a modular control system (both hardware and software) with distinct and independent units, which every unit has a defined functional task operation and interface is preferred and proposed.

It should be noted that the information of the disclosure in the Background above is only used to enhance the understanding of the background of the present invention, and therefore may include information that does not constitute the prior art known to those of ordinary skill in the art.

### SUMMARY OF THE INVENTION

The present disclosure provides a modular control system and method for controlling an AGV in order to overcome at least one of the above-mentioned drawbacks.

An object of the present disclosure is to provide a modular control system and method for controlling the AGV, so as to control the AGV to generate a map of its surrounding, locate its own position within the map, plan a path to a target position, and move to a target position, and the proposed architecture facilitates upgrading with new hardware, software, or algorithm introduced.

According to the present disclosure, a modular control system for controlling an AGV includes an interface, a processor, and a memory. The interface is used for receiving a command signal from an AGV management system and sensor signals from a plurality of sensors. The memory is used for storing a surrounding map and a plurality of programs to be executed by the processor. The plurality of programs include a task scheduling module, a sensor fusion module, a mapping module, and a localization module. The task scheduling module receives the command signal from the interface for converting the command signal to generate an enabling signal corresponding to the received command signal. The sensor fusion module receives the sensor signals and the enabling signal for processing the received sensor signals according to the enabling signal and generates an organized sensor data. The mapping module, according to the enabling signal, processes the organized sensor data and the surrounding map to generate an updated surrounding map, and stores the updated surrounding map into the memory. The localization module, according to the enabling signal, processes the organized sensor data and the updated surrounding map to generate a location and pose signal.

In yet another embodiment of the present disclosure, a method for controlling the AGV is provided. The method includes the steps of: (a) providing a modular control system comprising an interface, a processor, and a memory, wherein the memory stores a surrounding map and a plurality of programs to be executed by the processor, and the plurality of programs comprises a task scheduling module, a sensor fusion module, a mapping module, and a localization module; (b) the modular control system communicating through the interface to an AGV management system for receiving a command signal; (c) the modular control system communicating through the interface to a plurality of sensors for receiving sensor signals; (d) the task scheduling module receiving the command signal from the interface, and converting the received command signal to generate an enabling signal corresponding to the received command signal; (e) the sensor fusion module receiving the sensor signals and the enabling signal, processing the received sensor signals according to the enabling signal, and generating an organized sensor data; (f) the mapping module, according to the enabling signal, processing the organized sensor data and the surrounding map to generate an updated surrounding map, and storing the updated surrounding map into the memory; and (g) the localization module, according to the enabling signal, processing the organized sensor data and the updated surrounding map to generate a location and pose signal.

The above contents of the present disclosure will become more readily apparent to those ordinarily skilled in the art after reviewing the following detailed description and accompanying drawings.

### BRIEF DESCRIPTION OF THE DRAWINGS

FIG. 1 schematically illustrates the systematic architecture of an AGV of the prior art;

FIG. 2 schematically illustrates the proposed architecture of a modular control system for controlling the AGV according to a first embodiment of the present disclosure;

FIG. 3 schematically illustrates the operations of the plurality of programs shown in FIG. 2;

FIG. 4 is a flow diagram showing the method for controlling the AGV according to the first embodiment of the present disclosure;

FIG. 5 schematically illustrates the proposed architecture of the modular control system for controlling the AGV according to a second embodiment of the present disclosure;

FIG. 6 schematically illustrates the operations of the plurality of programs shown in FIG. 5;

FIG. 7 schematically illustrates the proposed architecture of the mapping module;

FIG. 8 schematically illustrates the detailed process flow diagram of the parallel fusion policy;

FIG. 9 schematically illustrates the detailed process flow diagram of the central fusion policy;

FIG. 10 schematically illustrates the proposed architecture of the modular control system for controlling the AGV according to a third embodiment of the present disclosure;

FIG. 11 schematically illustrates the proposed architecture of FIG. 10 in more detail;

FIG. 12 schematically illustrates the mapping operation flow of the AGV;

FIG. 13 schematically illustrates the detailed process flow diagram of the AGV mapping;

FIG. 14 schematically illustrates the localization operation flow of the AGV;

FIG. 15 schematically illustrates the detailed process flow diagram of the AGV localization;

FIG. 16 schematically illustrates the flow chart of repositioning when positioning is lost;

FIG. 17 schematically illustrates the navigation operation flow of the AGV;

FIG. 18 schematically illustrates the detailed process flow diagram of the AGV navigation;

FIG. 19 schematically illustrates some examples of the navigation process being executed during path planning;

FIG. 20 schematically illustrates the auto-mapping operation flow of the AGV;

FIG. 21 schematically illustrates the example images of the AGV auto-mapping;

FIG. 22 schematically illustrates the docking operation flow of the AGV;

FIG. 23 schematically illustrates the example images of the AGV docking;

FIG. 24 schematically illustrates the safety operation flow of the AGV;

FIG. 25 schematically illustrates the structure of a navigation sensor unit;

FIG. 26 schematically illustrates the structure of a docking sensor unit;

FIG. 27 schematically illustrates the structure of a core computing unit;

FIG. 28 schematically illustrates an example of a conveyor AGV;

FIG. 29 schematically illustrates an example of a one-way tunnel AGV;

FIG. 30 schematically illustrates an example of a two-way tunnel AGV;

FIGS. 31 and 32 schematically illustrate an example of a forklift AGV in different views;

FIG. 33 schematically illustrates an example of a lifting AGV;

and

FIGS. 34 and 35 schematically illustrate an example of a unit load AGV in different views.

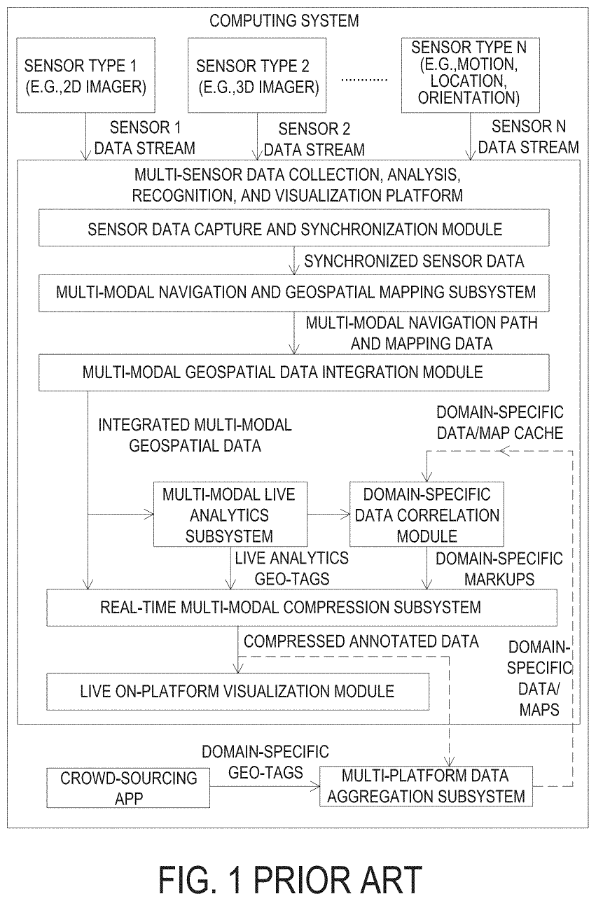

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

Comparing with the conventional AGV framework, the modular control system and method for controlling an AGV provided in the present disclosure adopts an open software architecture and standardized hardware modules with multiple and possible combinations to achieve the following advantages: 1) design and implement a new AGV or upgrade an existing AGV quickly and easily; 2) re-use software and hardware modules to achieve minimally essential AGV functional tasks; 3) adapt to different types of AGV vehicle platform; 4) open to improve in combination with new sensors or perception devices; and 5) open interface to high level of AGV management systems (e.g., Fleet management system).

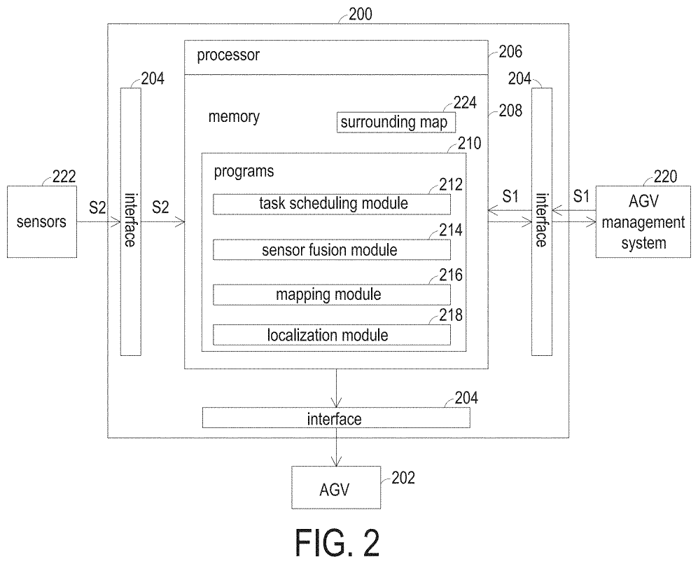

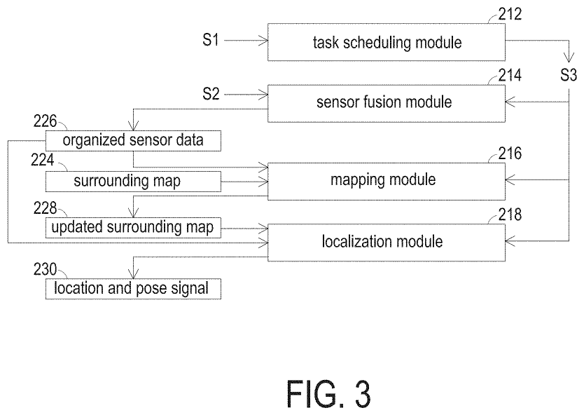

Please refer to FIG. 2, which schematically illustrates the proposed architecture of a modular control system for controlling the AGV according to a first embodiment of the present disclosure. As shown in FIG. 2, the modular control system 200 for controlling the AGV 202 includes an interface 204, a processor 206, a memory 208, and a plurality of programs 210 to support the AGV for the essential functional tasks of: (a) mapping; (b) localization; (c) navigation; (d) automatic mapping; (e) docking; and (f) safety (optionally). The plurality of programs 210 include a task scheduling module 212, a sensor fusion module 214, a mapping module 216, and a localization module 218. The interface 204 receives a command signal S1 from an AGV management system 220 and sensor signals S2 from a plurality of sensors 222. The memory 208 stores a surrounding map 224 and the plurality of programs 210 to be executed by the processor 206. FIG. 3 further schematically illustrates the operations of the plurality of programs shown in FIG. 2. The task scheduling module 212 receives the command signal S1 from the interface 204 for converting the received command signal S1 to generate an enabling signal S3 corresponding to the received command signal S1. The sensor fusion module 214 receives the sensor signals S2 and the enabling signal S3 for processing the received sensor signals S2 according to the enabling signal S3, and generates an organized sensor data 226. The mapping module 216, according to the enabling signal S3, processes the organized sensor data 226 and the surrounding map 224 to generate an updated surrounding map 228, and stores the updated surrounding map 228 into the memory 208. The localization module 218, according to the enabling signal S3, processes the organized sensor data 226 and the updated surrounding map 228 to generate a location and pose signal 230.

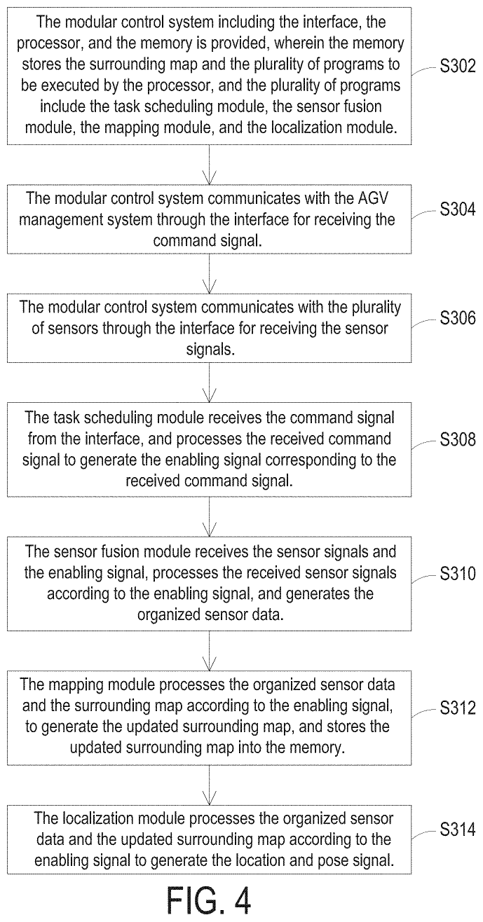

On the other hand, the present disclosure also provides a method for controlling the AGV. FIG. 4 is a flow diagram showing the method for controlling the AGV according to an embodiment of the present disclosure. The method includes the following steps.

In step S302, the modular control system 200 including the interface 204, the processor 206, and the memory 208 is provided, wherein the memory 208 stores the surrounding map 224 and the plurality of programs 210 to be executed by the processor 206, and the plurality of programs 210 include the task scheduling module 212, the sensor fusion module 214, the mapping module 216, and the localization module 218.

In step S304, the modular control system 200 communicates with the AGV management system 220 through the interface 204 for receiving a command signal S1.

In step S306, the modular control system 200 communicates with the plurality of sensors 222 through the interface 204 for receiving the sensor signals S2.

In step S308, the task scheduling module 212 receives the command signal S1 from the interface 204, and processes the received command signal S1 to generate the enabling signal S3 corresponding to the received command signal S1.

In step S310, the sensor fusion module 214 receives the sensor signals S2 and the enabling signal S3, processes the received sensor signals S2 according to the enabling signal S3, and generates the organized sensor data 226.

In step S312, the mapping module 216 processes the organized sensor data 226 and the surrounding map 224 according to the enable signal S3 to generate the updated surrounding map 228, and stores the updated surrounding map 228 into the memory 208.

In step S314, the localization module 218 processes the organized sensor data 226 and the updated surrounding map 228 according to the enable signal S3 to generate the location and pose signal 230.

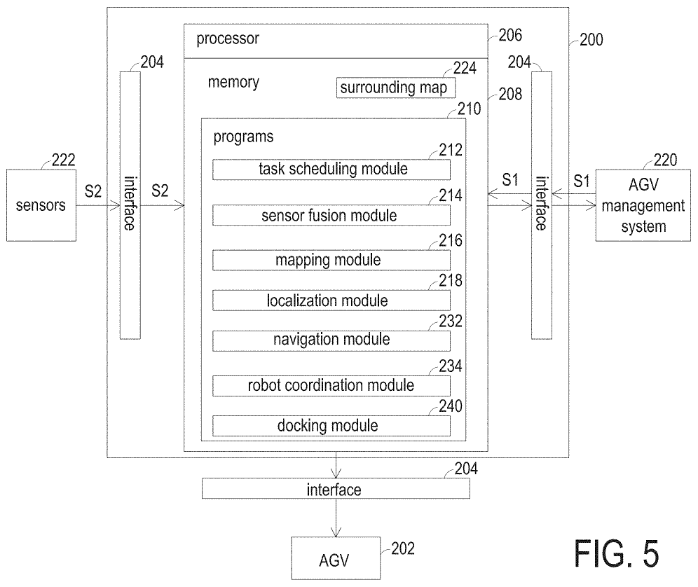

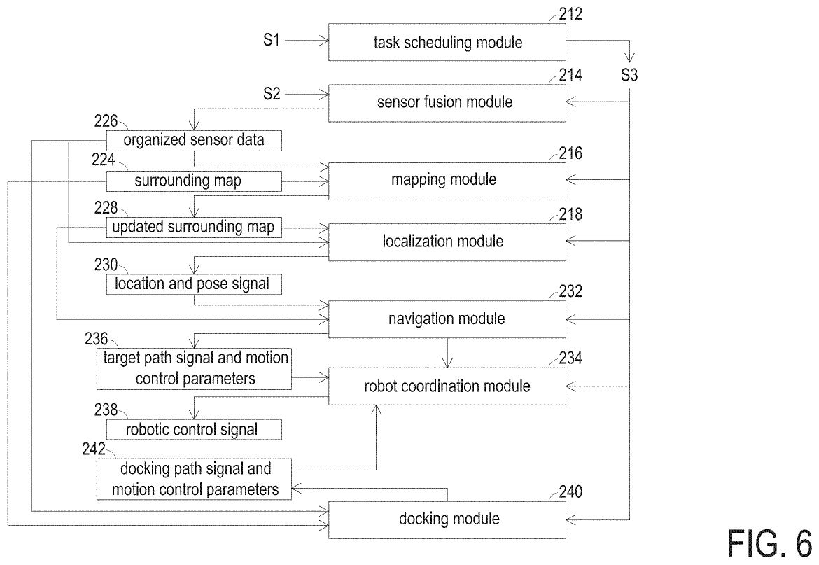

FIG. 5 schematically illustrates the proposed architecture of the modular control system for controlling the AGV according to a second embodiment of the present disclosure, and FIG. 6 further schematically illustrates the operations of the plurality of programs shown in FIG. 5. In one embodiment, the plurality of programs 210 further include a navigation module 232 and a robot coordination module 234. According to the enabling signal S3, the navigation module 232 processes the location and pose signal 230 and the updated surrounding map 228 to generate a target path signal and motion control parameters 236. According to the enabling signal S3, the robot coordination module 234 processes the target path signal and the motion control parameters 236 to generate a robotic control signal 238 for controlling the motion of the AGV.

In one embodiment, the interface 204 includes a north bound interface for communicating with the AGV management system 220 to receive the command signal S1 and to transmit the updated surrounding map 228, the location and pose signal 230, or the target path signal and the motion control parameters 236 to the AGV management system 220.

In another embodiment, the interface 204 includes a vehicle command interface which transmits the robotic control signal 238 to motors or actuators of the AGV 202 for controlling the motion of the AGV 202.

In another embodiment, the interface 204 includes a material handling command interface which transmits the robotic control signal 238 to motors or actuators of a robot attached to the AGV 202 for controlling the motion or position of the robot.

In another embodiment, the interface 204 includes a sensor interface for receiving the sensor signals S2 from various sensors 222 including 2D or 3D vision sensor, LIDAR (Light Detection And Ranging) sensor, IMU (Inertial Measurement Unit) sensor, or robot odometry sensor. The sensor interface pre-processes the sensor signals S2 by filtering out error or irrelevant sensor data and formatting the sensor data into predefined format to generate pre-processed sensor signals.

In one embodiment, according to a pre-defined fusion policy or a dynamic fusion policy, the sensor fusion module 214 synchronizes or aggregates by weightage the pre-processed sensor signals to generate the organized sensor data 226, and the fusion policy includes a parallel fusion policy or a central fusion policy.

In another embodiment of the present disclosure, the plurality of programs 210 further include a docking module 240. According to the enabling signal S3, the docking module 240 processes the organized sensor data 226 and the surrounding map 224 to generate a docking path signal and motion control parameters 242. In a further embodiment, according to the enabling signal S3, the robot coordination module 234 processes the docking path signal and the motion control parameters 242 to generate the robotic control signal 238 for controlling the motion of the AGV 202.

In another embodiment, the interface 204 further includes a vehicle command interface which transmits the robotic control signal 238 to motors or actuators of the AGV 202 for controlling the motion of the AGV 202 to a docket position.

In another embodiment, the interface 204 further includes a material handling command interface which transmits the robotic control signal 238 to motors or actuators of a robot attached to the AGV 202 for controlling the motion or position of the robot.

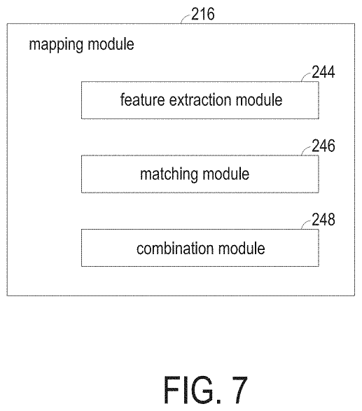

Please refer to FIG. 7, which schematically illustrates the proposed architecture of the mapping module. The mapping module 216 includes a feature extraction module 244, a matching module 246, and a combination module 248. The feature extraction module 244 extracts spatial features from the organized sensor data 226 to generate extracted features. The matching module 246 matches the extracted features with the surrounding map 224 to obtain a matching result. The combination module 248, according to the extracted features, the location and pose signal 230 and the matching result, to generate the updated surrounding map 228.

The AGV management system with high-level software applications includes fleet management system, Manufacturing Execution Systems (MES), and manual operator request of functional task. The AGV management system will be communicated with relevant parameters (e.g., mapping command, estimated target pose, localization command, localization mode, target pose, target speed, target acceleration, navigation command, auto-mapping command, region of interest, estimated target pose, docking command, docking mode, docking target, estimated start pose etc.) input for functional tasks and transmit the command signal to the task scheduling module via the north bound interface.

In the task scheduling module operation, the task scheduling module plays the role for converting the command signal to generate the enabling signal and issue the enabling signal to the plurality of programs with variety of functional task modules. The functional task modules include the mapping module, the localization module, the navigation module, and the robot coordination module.

In the sensor fusion module operation, the sensor fusion module is the program for combining data from multiple physical sensors in real-time, while also adding information from mathematical models, to create an accurate picture of the local environment. The fusion policy includes the parallel fusion policy or the central fusion policy.

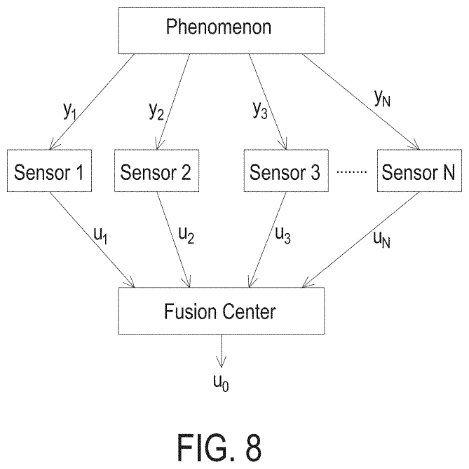

Please refer to FIG. 8, which schematically illustrates the detailed process flow diagram of the parallel fusion policy. According to the parallel fusion policy, the original data are obtained by each independent sensor and processed locally, and then the results are sent to the information fusion center for intelligent optimization and combination to obtain the final result. The distributed (parallel) fusion method has low demand for communication bandwidth, fast calculation speed, good reliability and continuity, but the accuracy of tracking is far less than that of the centralized fusion method.

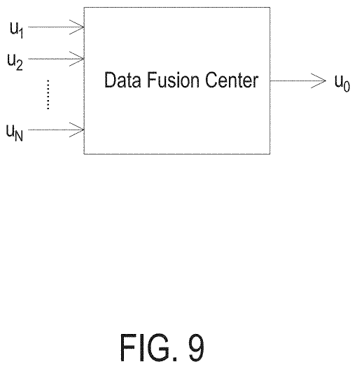

Please refer to FIG. 9, which schematically illustrates the detailed process flow diagram of the central fusion policy. According to the central fusion policy, the centralized raw data obtained by each sensor is directly sent to the central processing unit for fusion processing. Its data processing precision is high and the algorithm is flexible. However the disadvantage is high processor requirement, low reliability, and large data volume, which makes it difficult to implement.

In the mapping module operation, the organized sensor data is passed to the mapping module with feature extraction module for extracting various spatial features (e.g., edges, planes, static or dynamic object, etc.) and the matching module for performing the extracted features matching. A combination of organized sensor data, extracted features, and AGV's pose estimation data is processed by the combination module to generate or update the 2D or 3D surrounding map of the AGV. The latest surrounding map will be updated to the updated surrounding map and stored to the memory.

In the localization module operation, the organized sensor data is passed to the localization module for determining and estimating the AGV's relative position with reference to the latest surrounding map (2D costmap or 3D point cloud). If there is no existing map of the environment, the latest organized sensor data based on the AGV's immediate surrounding will be used to form the first map which is stored to memory.

In the navigation module operation, the AGV is equipped with multiple sensors including robot odometry sensor, 2D or/and 3D sensor (e.g., LIDAR or/and VISION) or/and the IMU sensor (optional). These sensors are used to construct 2D/3D maps of the environment. A navigation module on the AGV precisely locates and orients the AGV in geo-spatial coordinates using sensor signal from 2D or/and 3D sensor (e.g., LIDAR or/and VISION) or/and the IMU sensor, odometer, compass and camera based sensors.

In the docking module operation, the first stage is the same functional task as the navigation module in order to get close to the target object. The second stage is for a new functional task to identify the target object and control the docking operation by the docking module.

In one embodiment, the interfaces include the north bound interface, the vehicle command interface, the material handling command interface, and the sensor interface. The sensor signal with raw data from the 2D or/and 3D sensor (e.g., LIDAR or/and VISION) or/and the IMU sensor (optional) is transmitted to the sensor interface by a unified communication interface (e.g., serial or ethernet-based communication).

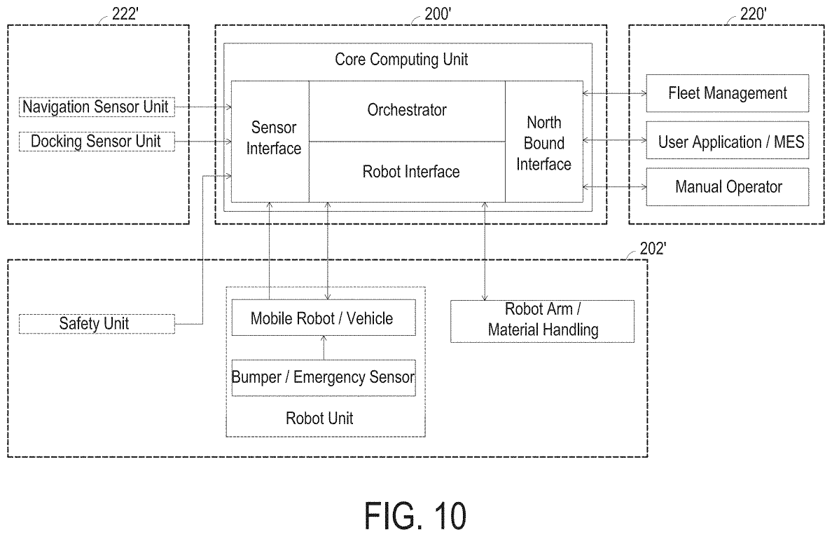

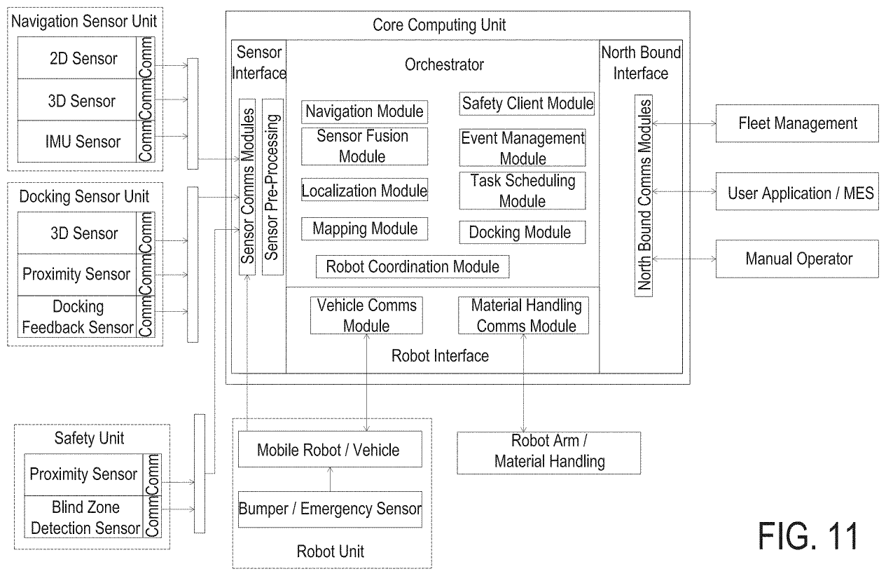

FIG. 10 schematically illustrates the proposed architecture of the modular control system for controlling the AGV according to a third embodiment of the present disclosure, and FIG. 11 schematically illustrates the proposed architecture of FIG. 10 in more detail. As shown in FIGS. 10 and 11, the modular control system 200′ is examplified by a core computing unit, the AGV management system 220′ is examplified by including high-level software applications (e.g., fleet management, user application or MES) and manual operator request, the sensors 222′ are examplified by including a navigation sensor unit and a docking sensor unit, and the AGV 202′ is examplified by including a robot unit, a robot arm or a material handling unit, and a safety unit (optional), which are external hardware for robot control and monitoring.

In the core computing unit, the processor and the memory are examplified by the orchestrator storing and executing the plurality of programs. The plurality of programs include the task scheduling module, the sensor fusion module, the mapping module, the localization module, the navigation module, the robot coordination module, and the docking module. Optionally, the plurality of programs further include a safety client module and an event management module. Moreover, the interface is examplified by including the north bound interface with the north bound communication module, the sensor interface with the sensor communication module, and the robot interface, which includes the vehicle command interface with the vehicle communication module, and the material handling command interface with the material handling communication module.

Each of the navigation sensor unit and the docking sensor unit includes multiple sensors, and communicates with the core computing unit through the sensor interface. For example, the navigation sensor unit includes the 2D sensor, the 3D sensor, and the IMU sensor, and the docking sensor unit includes the 3D senor, the proximity sensor, and the docking feedback sensor. The sensor signals received from the navigation sensor unit and the docking sensor unit may be pre-processed by the sensor interface or by the sensor fusion module.

The robot unit includes the mobile robot or vehicle and the bumper or emergency sensor, and the robot unit communicates with the core computing unit through the vehicle command interface. The robot unit further includes a robot odometry sensor which communicates with the core computing unit through the sensor interface to transmit odometry information (e.g. odometer data). The robot arm or the material handling unit communicates with the core computing unit through the material handling command interface. The safety unit includes the proximity sensor and the blind zone detection sensor, and the safety unit communicates with the core computing unit through the sensor interface.

The proposed modular control system supports the communication with higher-level external application software and the lower-level external hardware robot control. The orchestrator in the core computing unit includes all the essential functions that support AGV and mobile robot platform: (a) mapping, (b) localization, (c) navigation, (d) automatic mapping, (e) docking, and (f) safety.

The following paragraphs and figures show the process and data flow for each of the essential AGV functional task across the hardware and software modules/subsystems.

(a) Mapping Operation Flow

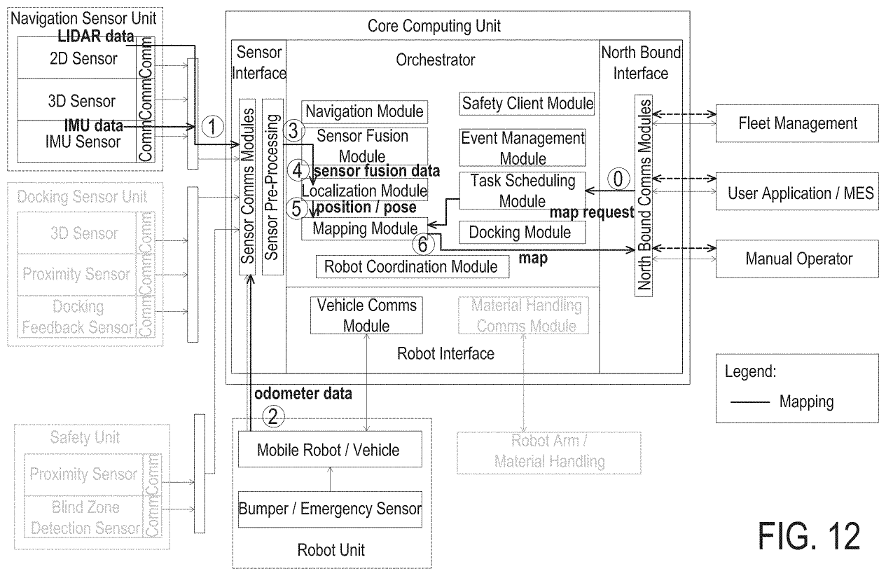

Please refer to FIG. 12, which schematically illustrates the mapping operation flow of the AGV. As shown in FIG. 12:

Step 0: The AGV management system with high-level software applications (e.g., Fleet management or MES) or manual operator requesting of AGV mapping operations (map request) will be communicated with relevant parameters (e.g., mapping command, estimated target pose, etc.) to the task scheduling module via the north bound interface. The task scheduling module then issues a mapping request by the enabling signal to the mapping module. The mapping module will calculate a map representation of the AGV's surrounding following these steps.

Step 1: The sensor signal with raw data from the 2D or/and 3D sensor (e.g., LIDAR or/and VISION) or/and the IMU sensor (optional) in the navigation sensor unit is transmitted to the sensor interface of the core computing unit through a unified communication interface (e.g., serial or ethernet-based communication). Pre-processing of sensor data is performed to filter bad or irrelevant data, format into required format and transform into derived values.

Step 2: The sensor interface of the core computing unit obtains the odometry information/odometer data (optional) from the robot unit, and processes this data (filter, format and transform) as required by the sensor fusion module.

Step 3: The input sensor data (digital signal from LIDAR or camera) from steps 1 and 2 will next be transmitted to the sensor fusion module in the orchestrator after pre-processing. Here the sensor data will be synchronized and aggregated with varying weightage by the sensor fusion module based on pre-defined or dynamic sensor fusion policies to generate the organized sensor data. This process works for different type of sensor fusion methods (e.g., parallel fusion method, centralized fusion method, etc.).

Step 4: The organized sensor data (also called sensor fusion data) from step 3 is then passed to the localization module to determinate/estimate the AGV's relative position with reference to the latest local or surrounding map (2D costmap or 3D point cloud). If there is no existing map of the environment, the latest organized sensor data based on the AGV's immediate surrounding will be used to form the first surrounding map which is stored to memory.

Step 5: At the same time the organized sensor data from step 3 is passed to the mapping module which extracts various spatial features (e.g., edges, planes, static or dynamic object, etc.) and performs features matching. A combination of organized sensor data, extracted features, and AGV's pose estimation data is processed to generate or update the 2D or 3D surrounding map of the AGV as the updated surrounding map. This latest local map will be updated to the AGV's map and stored to memory.

Step 6: In the final step, the mapping module sends the newly generated or updated map data to the AGV management system and ends the map request service.

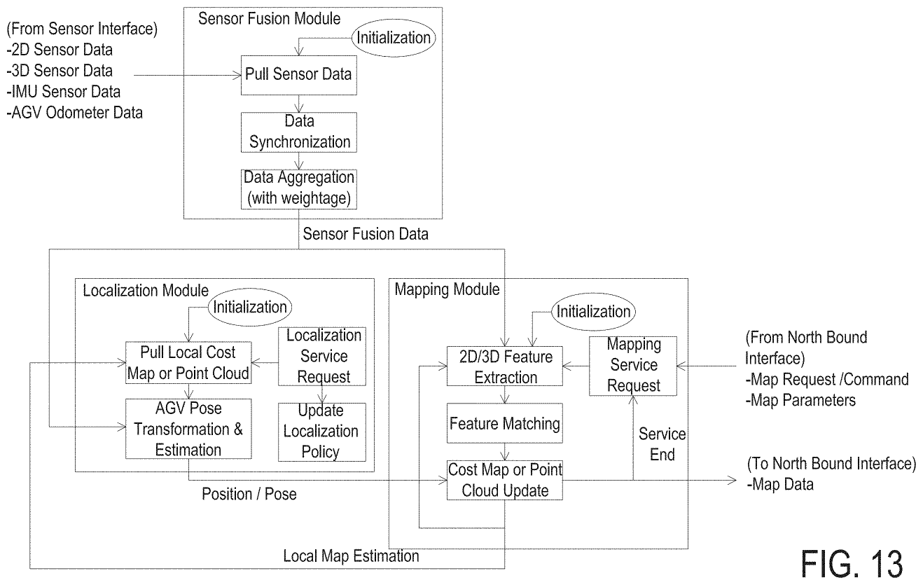

Please refer to FIG. 13, which schematically illustrates the detailed process flow diagram of AGV mapping. In the AGV mapping operation, the sensor fusion module processes raw sensor data (steps 1-3) of the sensor signals to generate the organized sensor data (sensor fusion data). Thereafter the localization module processes the sensor fusion data and the local map estimation (steps 4-5) to generate the position/pose data. Then the mapping module processes the sensor fusion data and the position/pose data (step 6) to generate the map data, which is further transmitted to the AGV management system through the north bound interface.

(b) Localization Operation Flow

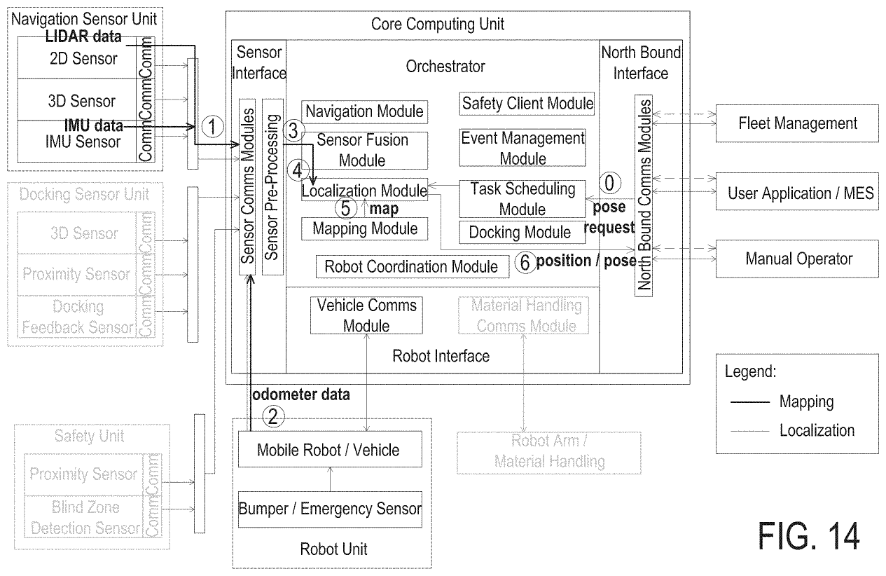

Please refer to FIG. 14, which schematically illustrates the localization operation flow of the AGV. As shown in FIG. 14:

Step 0: A localization service request (pose request) is triggered by the AGV management system with high-level software applications (e.g., Fleet management or MES) or manual operator with relevant parameters (e.g., localization command, localization mode, etc.) to the task scheduling module via the north bound interface. The task scheduling module then issues an AGV's pose/position request by the enabling signal to the localization module. The localization module will calculate the AGV's current 2D/3D pose with reference to its local 2D/3D map with the following steps.

Steps 1-4: Steps 1-4 of the localization operation are identical to those of the mapping operation's steps 1-4.

Step 5: At the same time (as steps 3 and 4) the organized sensor data from step 3 is passed to the mapping module which extracts various spatial features (e.g., edges, planes, static or dynamic object, etc.) and performs features matching. A combination of organized sensor data and extracted features is processed to generate or update the 2D or 3D surrounding map of the AGV as the updated surrounding map. The mapping module then sends the 2D or 3D surrounding map to the localization module for position/pose calculation.

Step 6: The localization module provides the position/pose information of robot in 2D/3D map coordinate system to the north bound interface and ends the service request.

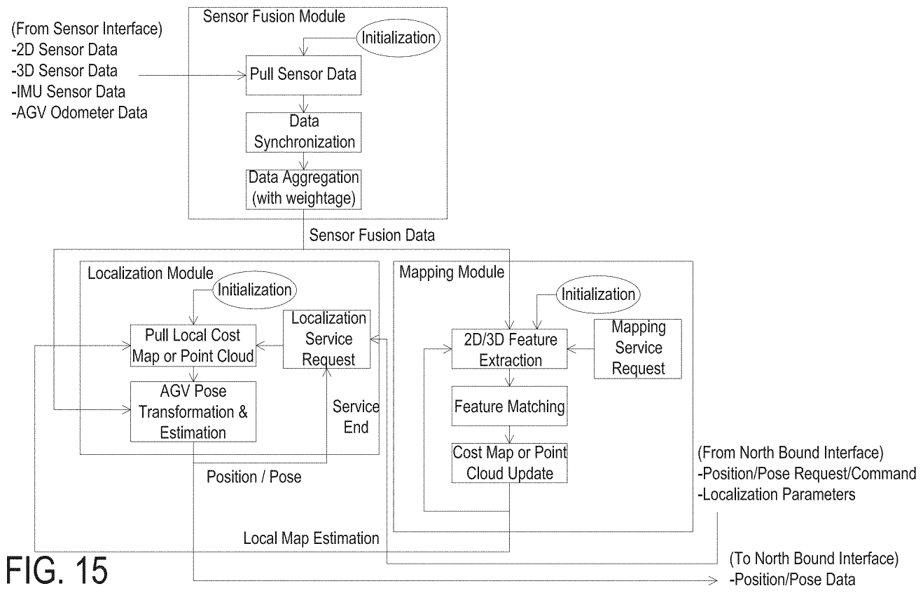

Please refer to FIG. 15, which schematically illustrates the detailed process flow diagram of AGV localization. In the localization operation, the sensor fusion module processes raw sensor data (steps 1-3) of the sensor signals to generate the organized sensor data (sensor fusion data). Thereafter the localization module processes the sensor fusion data and the local map estimation (steps 4-5) to generate the position/pose data. Particularly, the pull local cost map or point cloud submodule has a position/pose signal input which is given by the localization service request submodule. Then the AGV pose transformation and estimation submodule can generate a new position/pose signal and pass it to the localization service request submodule after obtaining the organized sensor data and the updated surrounding map.

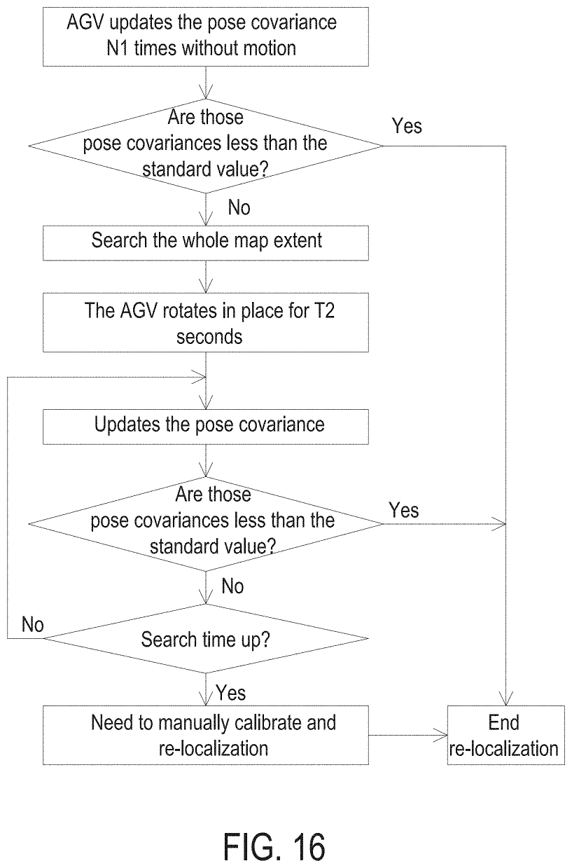

Please refer to FIG. 16, which schematically illustrates the flow chart of repositioning when positioning is lost. In the event of positioning loss, the process as shown in FIG. 16 will be executed independently to relocate and retrieve the correct position and attitude of the AGV. This will be an event-triggered process. This occurs in the AGV pose transformation and estimation function in the localization module, whereby the pose estimation value is collected over multiple (N1) iterations and the covariance is calculated and compared against a pre-defined or dynamic value. If the covariance of the pose estimation is higher than the standard value, a countermeasure (e.g., extend the search scan area and rotates the AGV slightly) may be performed over a brief duration (T2).

(c) Navigation Operation Flow

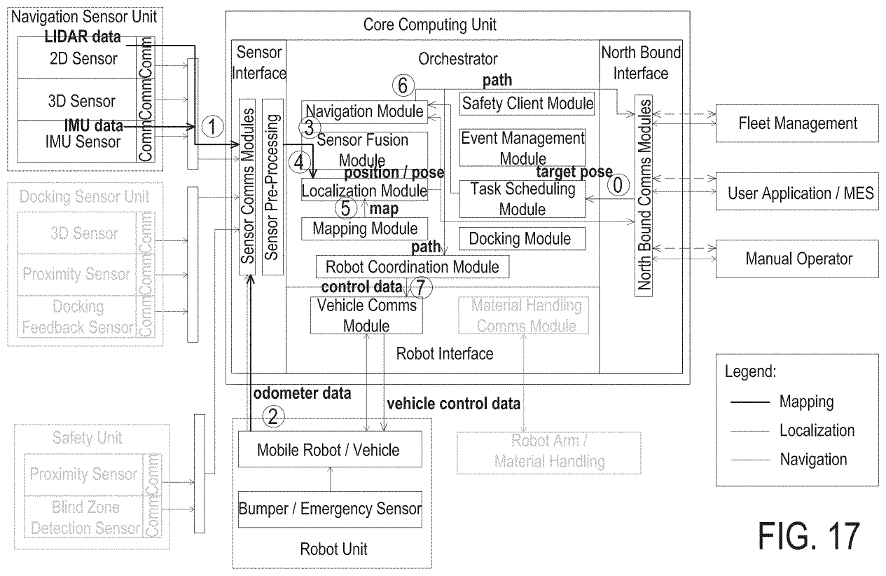

Please refer to FIG. 17, which schematically illustrates the navigation operation flow of the AGV. As shown in FIG. 17:

Step 0: The AGV management system with high-level software applications (e.g., Fleet management or MES) or manual operator requesting of AGV navigation operations will be communicated with relevant parameters (e.g., target pose, target speed, target acceleration, navigation command, etc.) to the task scheduling module via the north bound interface. The task scheduling module then issues a navigation request by the enabling signal to the navigation module. The navigation module will calculate the navigation/target path from current pose to target pose using the following steps.

Steps 1-5: Steps 1-5 of the navigation operation are identical to those of the localization operation's steps 1-5.

Step 6: The navigation module will plan an optimal navigation path from current pose to target pose according to the local map information. The navigation module will then send the target path in map coordinate system to the north bound interface for real-time monitoring by the AGV management system. The optimal navigation path may be computed by various optimization methods (e.g., shortest part, lowest energy cost, etc.). The optimal navigation path usually consists of multiple waypoints by which the AGV would travel to reach the target pose.

Step 7: The navigation module sends an optimal navigation path from current pose to target pose together with motion control parameters (e.g., target speed, target acceleration) to the robot coordination module. The robot coordination module will then send a robotic control signal including vehicle control command and parameters (e.g., speed and acceleration, etc.) to the vehicle/robot to move it according to the planned path of motion.

Steps 6 and 7 are iterative steps that are repeated until the target pose is reached or there is an exception event (e.g., collision avoidance, safety event, etc.) that occurred.

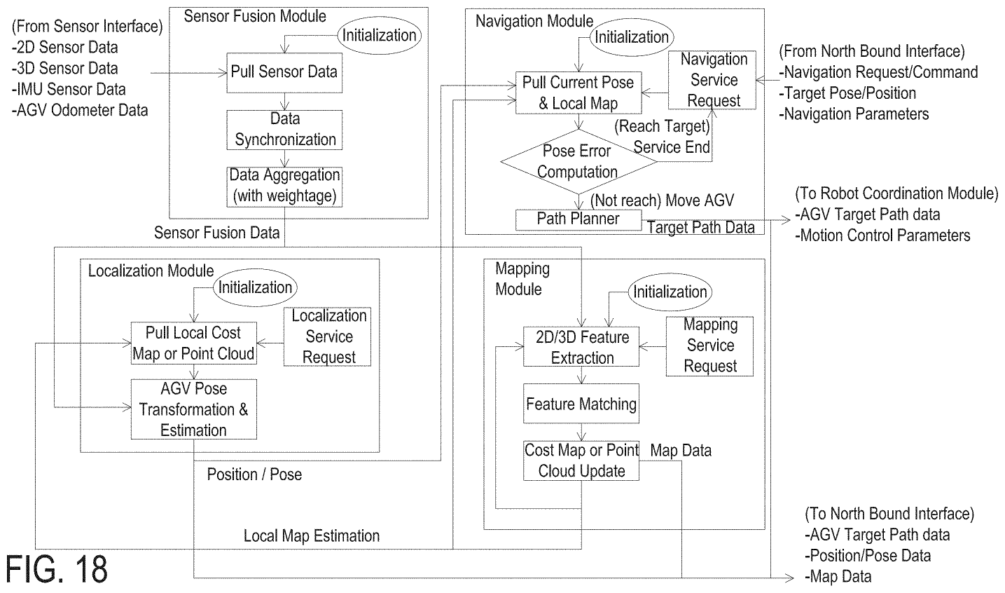

Please refer to FIG. 18, which schematically illustrates the detailed process flow diagram of AGV navigation. In the navigation operation, the sensor fusion module processes raw sensor data (steps 1-3) of the sensor signals to generate the organized sensor data (sensor fusion data), and the localization module processes the sensor fusion data and the local map estimation (steps 4-5) to generate the position/pose data. Thereafter the navigation module processes the position/pose data and the local map estimation (steps 6-7) to generate the target path data, and the mapping module processes the sensor fusion data to generate the map data.

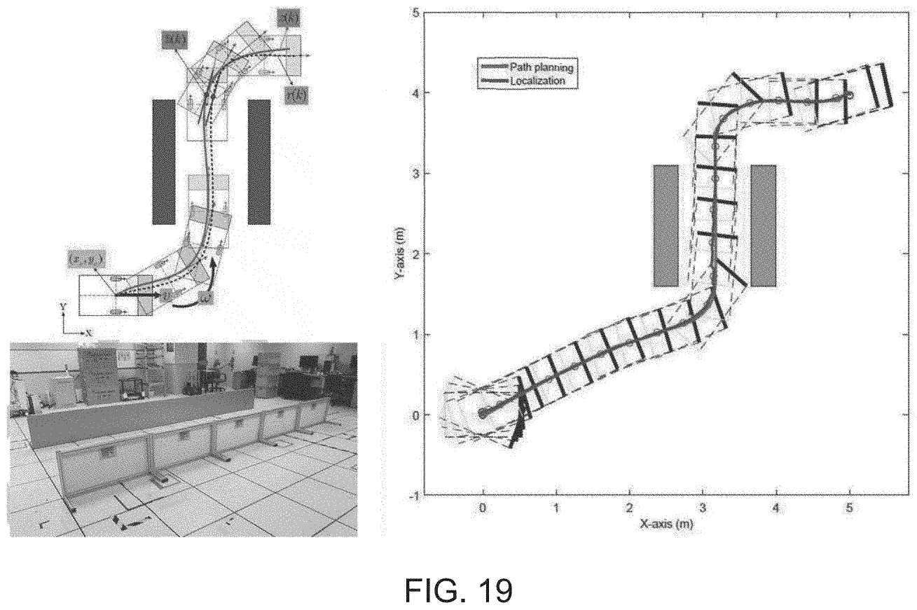

Please refer to FIG. 19, which schematically illustrates some examples of the navigation process being executed during path planning. Some examples of the navigation process being executed during path planning are provided as shown in FIG. 19. The examples illustrate how the AGV navigates through a straight corridor with multiple intermediate waypoints/steps from start point to end point.

(d) Auto-Mapping Operation Flow

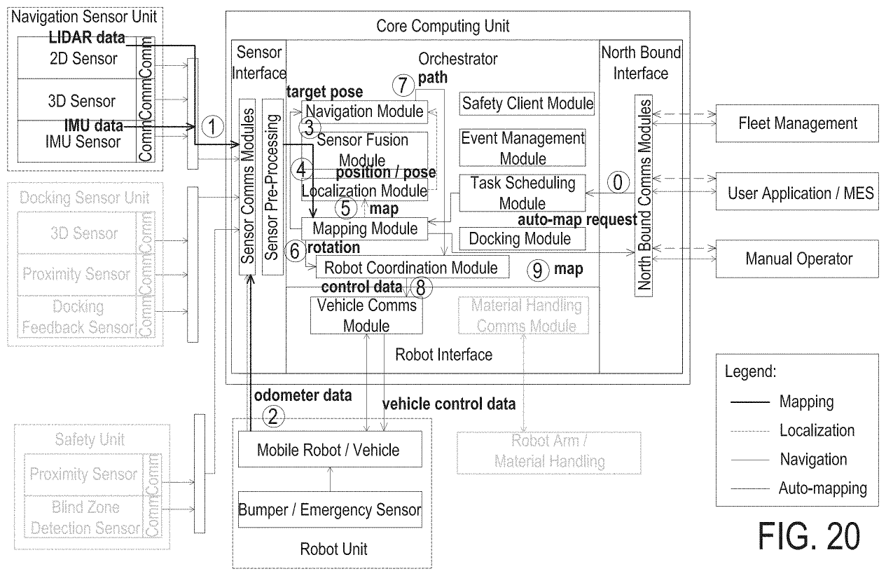

Please refer to FIG. 20, which schematically illustrates the auto-mapping operation flow of the AGV. As shown in FIG. 20:

Step 0: The AGV management system with high-level software applications (e.g., Fleet management or MES) or manual operator requesting of AGV auto-mapping operations will be communicated with relevant parameters (e.g., auto-mapping command, region of interest, estimated target pose, etc.) to the task scheduling module via the north bound interface. The task scheduling module then issues an auto-mapping request by the enabling signal to the mapping module. The mapping module proceeds with map exploration and calculates a map representation of the region of interest following these steps.

Steps 1-5: Steps 1-5 of the auto-mapping operation are identical to those of the localization operation's steps 1-5.

Step 6: Based on the first map that was generated with the AGV stationary in its first position, the mapping module may trigger a rotation of the AGV about its stationary point (optional) by sending a command to the robot coordination module, while repeating Steps 1-5. If not, the mapping module will send an exploratory target pose to the navigation module. Various auto-mapping strategies exist, which direct the AGV towards unexplored space by detecting frontiers. Frontiers are boundaries separating known space from unknown space.

Steps 7-8: Steps 7-8 of the auto-mapping operation are identical to those of the navigation operation's steps 6-7.

The steps 1-8 are repeated in exploration steps (to new frontiers) whereby the AGV identifies areas within the region of interest that is unknown and repeatedly updates the map with new data gathered. This continues until the entire region of interest that is accessible to the AGV is explored.

Step 9: The mapping module sends the updated map data repeatedly to AGV management system with high-level software applications via the north bound interface. This continues until the entire region of interest that is accessible to the AGV is explored, whereby the auto-mapping service is completed.

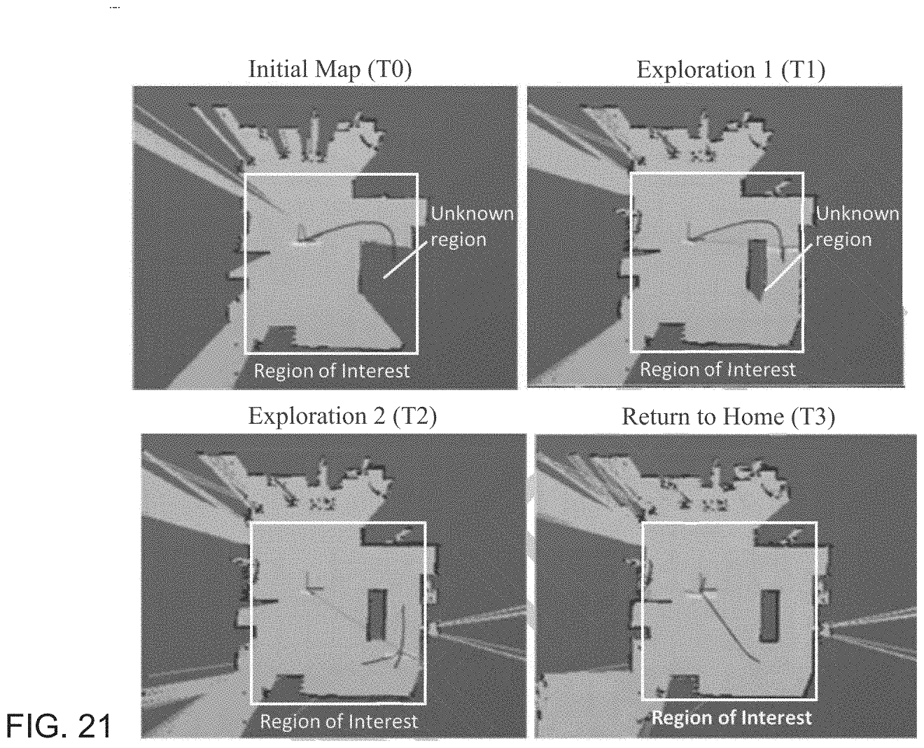

Please refer to FIG. 21, which schematically illustrates the example images of AGV auto-mapping. Some example images of the auto-mapping process that occurs through a series of exploration steps are provided as shown in FIG. 21. The example illustrates how the AGV explores unexplored regions in its environment through multiple exploration paths until the entire region of interest is covered.

(e) Docking Operation Flow

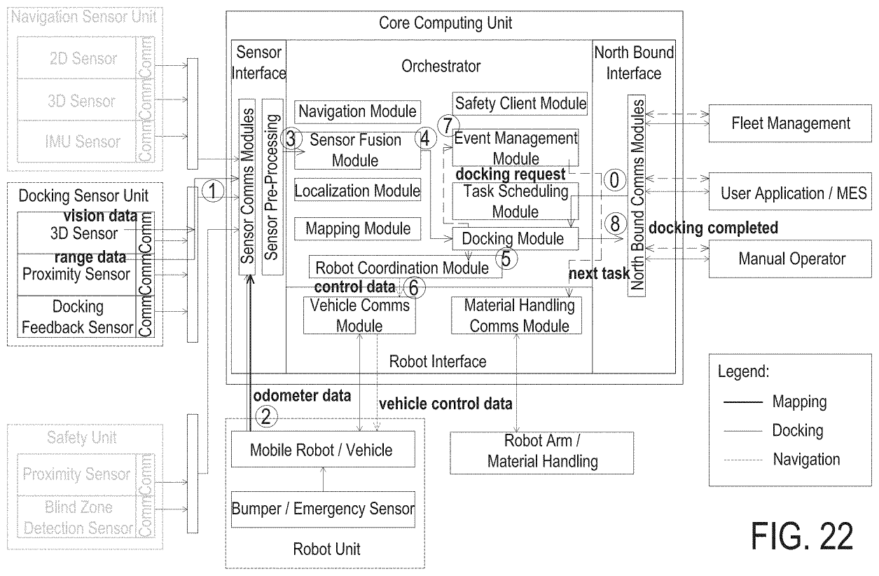

Please refer to FIG. 22, which schematically illustrates the docking operation flow of the AGV. As shown in FIG. 22:

Step 0: The AGV management system with high-level software applications (e.g., Fleet management or MES) or manual operator requesting of AGV docking operations will be communicated with relevant parameters (e.g., docking command, docking mode, docking target, estimated start pose, etc.) to the task scheduling module via the north bound interface. The task scheduling module then issues a docking request by the enabling signal to the docking module. The docking module will perform the automatic docking with docking stations (e.g., machines, shelves, trolleys, etc.) using the following steps.

Step 1: The sensor signal with raw data from the 3D sensor (e.g., 3D LIDAR or/and VISION) and the proximity sensor data (e.g., range, presence, etc.) in the docking sensor unit is transmitted to the sensor interface of the core computing unit through a unified communication interface (e.g., serial or ethernet-based communication). Pre-processing of the sensor data is performed to filter bad or irrelevant data, format into required format and transform into derived values.

Steps 2-3: Steps 2-3 of the docking operation are identical to those of the mapping operation's steps 2-3.

Step 4: The organized sensor data from step 3 is then passed to the docking module to determinate/estimate the AGV's relative position with reference to the latest local map (2D costmap or 3D point cloud). This could be the standard 2D/3D map from the mapping module or a standalone one (which is usually of higher resolution) of the docking station in robot body coordinate system.

Steps 5 and 6: The docking module then sends an optimal docking path from current pose to docking pose together with motion control parameters (e.g., target speed, target acceleration) to the robot coordination module. The robot coordination module will then send vehicle control command and parameters (e.g., speed and acceleration, etc.) to the vehicle/robot unit to move it according to the planned path of motion. Steps 1-6 are repeated until the vehicle/robot unit is successfully dock with a feedback signal from the docking sensor unit (optional).

Step 7: (Optional) The docking module notifies the event management module that the docking is completed and a subsequent action for material handling may be triggered by sending a request/command to the robot arm/material handling unit via the material handling communication module.

Step 8: In the final step, the docking module sends docking completion signal and status update to the AGV management system with high-level software applications via the north bound interface and ends the docking request service.

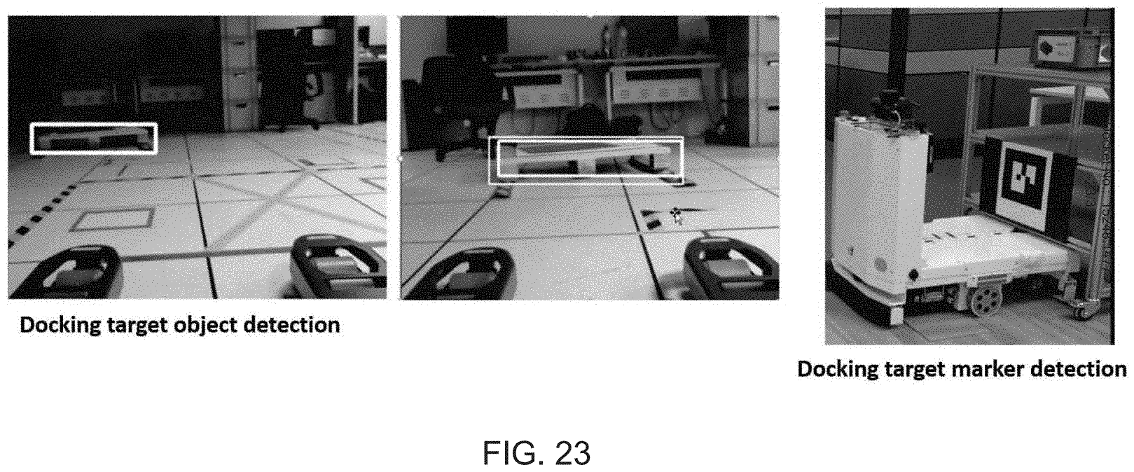

This process flow supports different methods of AGV docking (e.g., marker-based, edge-detection, etc.) for both 2D and 3D mapping. Please refer to FIG. 23, which schematically illustrates the example images of AGV docking. The examples illustrate a forklift AGV (left) docking itself to an empty pallet and a unit load AGV (right) docking itself to a trolley.

(f) Safety Operation Flow

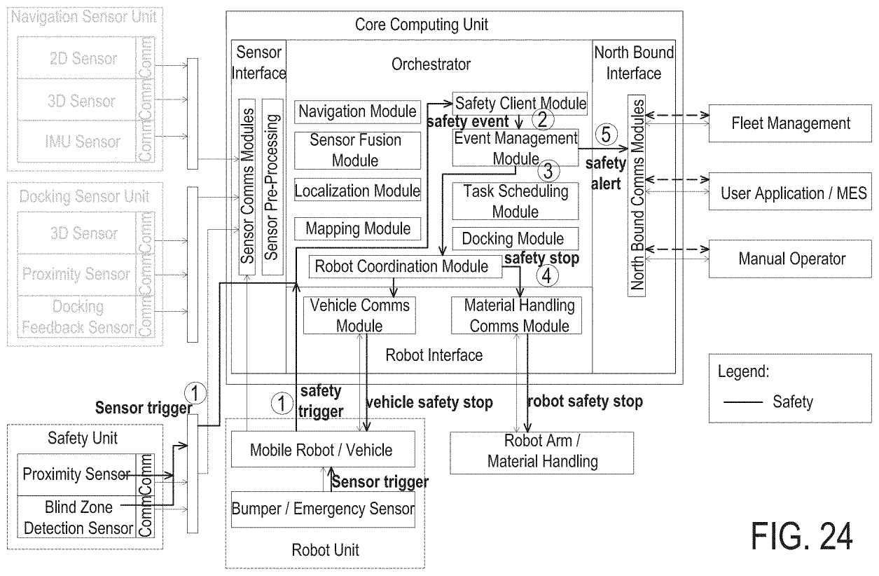

Please refer to FIG. 24, which schematically illustrates the safety operation flow of the AGV.

By design, the safety client module will be constantly monitoring safety sensor data and safety trigger. Safety trigger may come from the on-board safety sensors in the robot unit or the safety unit or even from the collision avoidance mechanism within the localization module. All safety triggers will activate the AGV safety operation through the following steps.

Step 1: Safety trigger signals may come from the proximity sensor data (e.g., range) and the blind zone detection sensor data (e.g., range) in the safety unit, and the safety alarms from the bumper and emergency sensor in the robot unit, which are directly transmitted to the safety client module. The communication is through low latency and low complexity protocols (e.g., I/O, IO-Link, etc.) that adhere to safety standard requirements.

Step 2: When the safety client module receives a safety trigger, raises a safety alert event/alarm to the event management module which in turn activates safe stop mechanism.

Steps 3 and 4: The event management module will send emergency commands to the robot coordinate module to make the vehicle/robot unit and the robot arm/material handling unit to perform an emergency stop.

Step 5: At the same time a safety alert alarm is sent to AGV management system with high-level software applications (e.g., fleet management/MES) to notify users of the safety event through the north bound interface.

In terms of hardware, 3 subsystems (navigation sensor unit, docking sensor unit, and core computing unit) may be reused on different AGV in multiple combinations and for various applications.

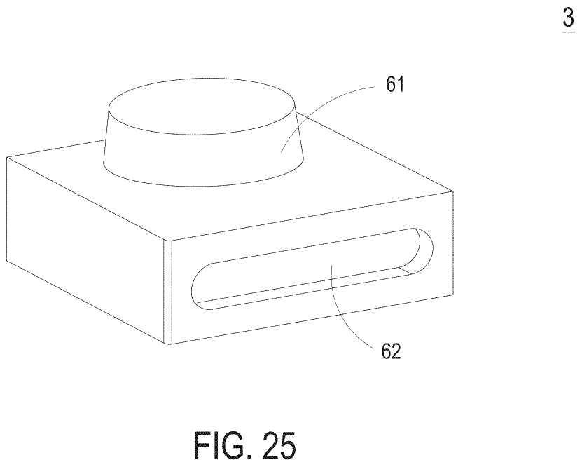

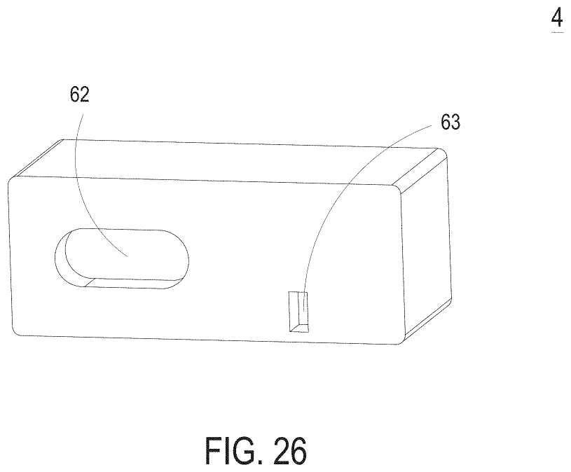

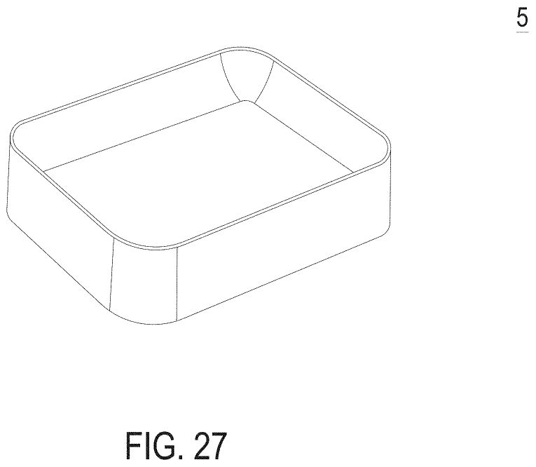

Please refer to FIG. 25, FIG. 26, and FIG. 27. FIG. 25 schematically illustrates the structure of a navigation sensor unit. FIG. 26 schematically illustrates the structure of a docking sensor unit. FIG. 27 schematically illustrates the structure of a core computing unit.

A navigation sensor unit is a modular subsystem that comprises a 360° 2D sensor (e.g., LIDAR), an 180° 3D sensor (e.g., depth camera, 3D LIDAR) and a communication interface. The sensor data from the navigation sensor unit provides a 2D and 3D image and range data required for AGV mapping, localization, navigation, auto-mapping operations. The communication interface ensures low latency and robust communication with the core computing unit which then processes the sensor data for precise mapping, pose estimation and collision avoidance in 3D environment.

A docking sensor unit is a modular subsystem that comprises an 180° 3D sensor (e.g., depth camera, 3D LIDAR), a proximity sensor (e.g., Infrared sensor) and a communication interface. The sensor data from the docking sensor unit provides a 3D image and range data required for AGV docking operations. The communication interface ensures low latency and robust communication with the core computing unit which then processes the sensor data for precise mapping, pose estimation and collision avoidance in 3D environment.

A core computing unit is a modular subsystem that comprises a computing unit (e.g., embedded system, mini-PC, IPC), a power unit and a communication interface. The computing unit has an operating system with a plurality of programs including all required software modules and system drivers installed. The power unit provides the necessary power conversion from external power or battery, distributes the power to all subsystems and allows manual or auto power on/off and restart. The communication interface ensures low latency and robust communication with the navigation sensor unit, the docking sensor unit and (optional) the safety unit.

A combination of 1 set of navigation sensor unit, 1 set of docking sensor unit and 1 set of core computing unit is the minimal requirement for a one directional (forward) travel, and additional 1 set of navigation sensor unit is required for two directional (forward, backward) and omnidirectional travel. The following paragraphs and figures illustrate the combinations of the 3 subsystems that can be used (but not limited to) for multiple AGV types.

(1) Conveyor AGV

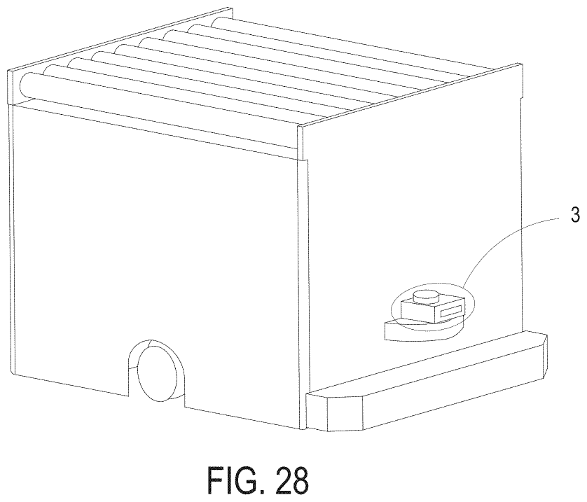

Please refer to FIG. 28, which schematically illustrates an example of a conveyor AGV. A proposed combination of one navigation sensor unit, one core computing unit, and one docking sensor unit (optional) is shown for example.

(2) One-Way Tunnel AGV

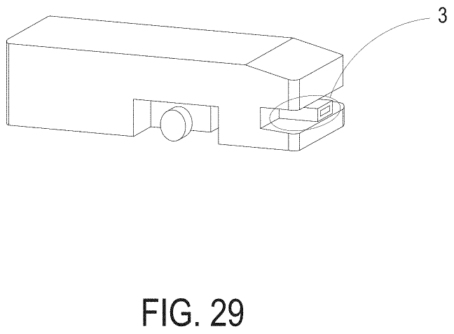

Please refer to FIG. 29, which schematically illustrates an example of a one-way tunnel AGV. A proposed combination of one navigation sensor unit and one core computing unit is shown for example.

(3) Two-Way Tunnel AGV

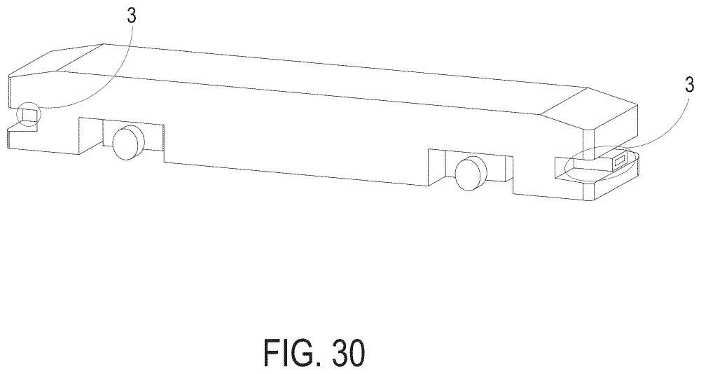

Please refer to FIG. 30, which schematically illustrates an example of a two-way tunnel AGV. A proposed combination of two navigation sensor units and one core computing unit is shown for example.

(4) Forklift AGV

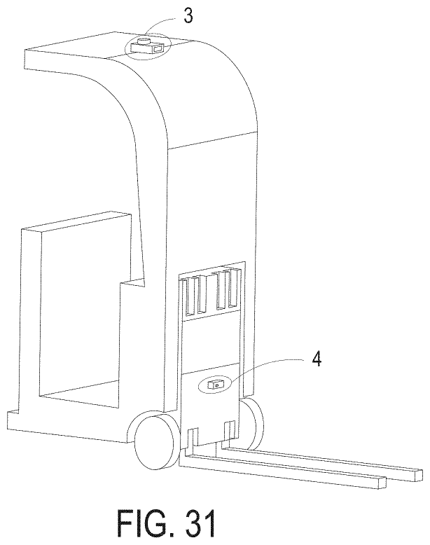

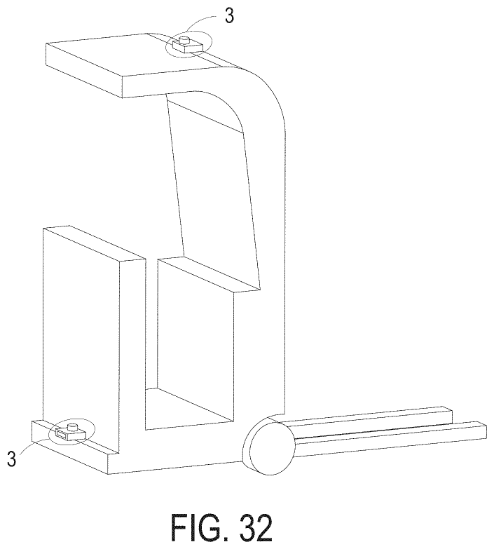

Please refer to FIG. 31 and FIG. 32, which schematically illustrate an example of a forklift AGV in different views. A proposed combination of two navigation sensor units, one core computing unit, and one docking sensor unit is shown for example.

(5) Lifting AGV

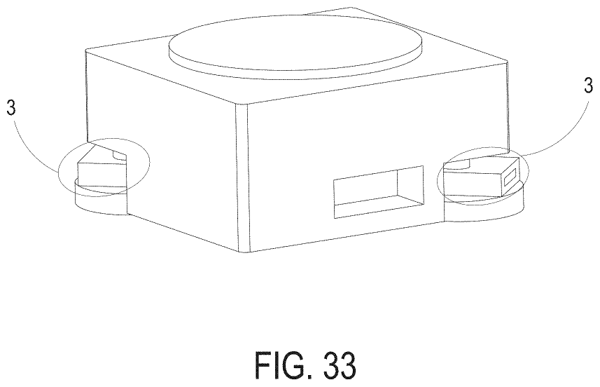

Please refer to FIG. 33, which schematically illustrates an example of a lifting AGV. A proposed combination of two navigation sensor units and one core computing unit is shown for example.

(6) Unit Load AGV

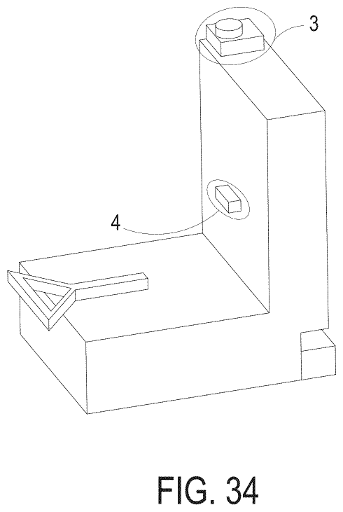

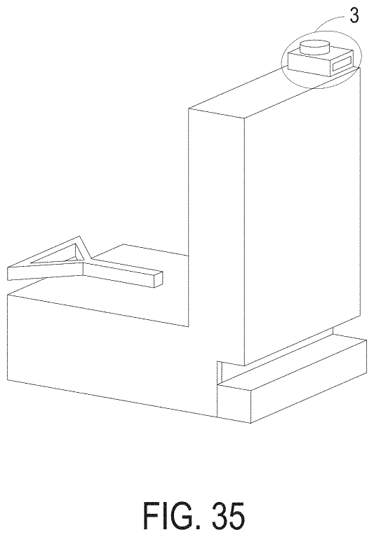

Please refer to FIG. 34 and FIG. 35, which schematically illustrate an example of a unit load AGV in different views. A proposed combination of one navigation sensor unit, one core computing unit, and one docking sensor unit is shown for example.

The proposed combinations of the navigation sensor unit, the docking sensor unit, and the core computing unit can be deployed, configured, and tested on different AGV platforms through the following generic steps. The modular hardware and software of the present disclosure can be immediately configured and used in different types of AGV and can even meet certain AGV safety regulations.

The recommended setting/calibration/test steps are described as following:

A. Setting AGV appearance, specifications, and parameter input:

Set the following parameters according to different AGV vehicle movement methods and docking equipment.

1. AGV size, maximum load weight (optional).

2. Driving wheels: type, number, wheel radius, placement, maximum speed.

3. Driven wheel (optional): type, number, wheel radius, placement.

4. Types and quantity of unit (module) used in AGV vehicle.

5. AGV communication interface test.

6. Definition of AGV external safety device.

B. Kits: Navigation/Docking Unit Calibration:

The following steps are recommended calibration methods for the navigation/docking unit.

Step 1: Set the definition of the placement of the navigation/docking unit: For different AGV, the illustration above may be referred to place the definition of the navigation/docking unit and set the configuration distance coordinates (relative to the center between the driving wheels).

Step 2: Navigation/docking unit communication interface test: Use the installed core computing unit to perform the communication connection test with the navigation/docking unit in order to perform the next steps.

Step 3: Sensor range setting: Set the maximum range that can be detected by the 2D/3D sensor in the navigation unit. Set the maximum range that can be detected by the 3D sensor in the docking unit.

Step 4: Mapping/localization function calibration (not necessary): Test the mapping/localization function in the navigation unit and use a known field size for calibration.

Step 5: Navigation function calibration (not necessary): Use the calibration map created in step 4 to set the position from point A to point B for calibration.

Step 6: Calibration of the docking function: Install the docking calibration label on the device to be docked and perform ID recording and docking position/pose calibration.

C. Safety Mechanism/Device/Equipment Verification:

The following are function and safety test and verification steps.

Step 1: Setting the internal safety mechanism of the kit: Set the navigation/docking unit's function of avoiding obstacles (e.g., AGV vehicle movement methods and braking rules far, middle and near from obstacles).

Step 2: AGV external safety contact obstacles buffer performance test (e.g., bumper): Turn off the internal safety mechanism setting of the kit, AGV runs at the rated speed, and place obstacles in the direction of AGV travel (diameter 50 mm, weight 55 kg or less). The AGV in motion stops when it encounters an obstacle. Test the moving distance forced to stop. The test is performed under no load and under load. The braking distance must not exceed the value specified by the AGV vehicle manufacturer.

Step 3: AGV external safety emergency stop performance test (for example: emergency stop button): AGV automatically runs at the rated speed. After pressing the emergency stop button at a pre-marked location on the linear trajectory, the AGV emergency stops and tests from the marked position to the stop. The distance of the position is tested 5 times each in the case of no load and specified load, forward and backward (except without the reverse function), and the braking distance must not exceed the value specified by the AGV vehicle manufacturer.

D. Fully Calibrated AGV Vehicle Motion Test:

The following step tests the motion of the AGV as a whole and is also the last step of the deployment process.

Step 1. Vehicle motion accuracy test: When the AGV is moving on the set path at the specified speed, the tester visually reads the maximum value of deviation from the baseline. The test is performed under no load and specified load, forward and backward (except without back function), and the accuracy of movement must not exceed the value specified by the AGV vehicle manufacturer.

Step 2. Vehicle maximum turning radius test: Automatically run at the set speed on the curve of the minimum rotation radius of the guideline specified by the AGV, and smoothly rotate on the guide trajectory. The transition between the various actions of the AGV is required to be smooth. Test separately under no load and with specified load.

According to the present disclosure, it is provided a multi-sensor modular system and method of real-time 3D mapping, localization, navigation and control of AGVs. The proposed system includes modular hardware and modular software. The modular hardware includes the navigation sensor unit, the docking sensor unit, the core computing unit, and the safety unit (optional). The modular software includes the task scheduling module, the sensor fusion module, the mapping module, the localization module, the navigation module, the robot coordination module, the docking module, the safety client module, the event management module, and the sensor/north bound/robot interface. The proposed system can control/guide different mobile robots or vehicles to generate a map of its surrounding (manually or automatically), locate its own position within the map, plan a path to a target position (given by external control system), move to a target position (given by external control system), detect nearby obstacles and avoid them, and dock to a static object (in a fixed location) for material handling or charging.

From the above descriptions, the present disclosure provides a modular control system and method for controlling an AGV. It is different from the conventional AGV framework, the modular control system and method adopts an open software architecture and standardized hardware modules with multiple possible combinations to achieve the advantages of designing and implementing a new AGV or upgrading an existing AGV quickly and easily, re-using software and hardware modules to achieve minimally essential AGV functional tasks, adapting to different types of AGV vehicle platform, being open to improvement with new sensors or perception devices and/or combinations thereof, and having an open interface to high level of AGV management system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A modular control system for controlling an automated guided vehicle (AGV), comprising:
an interface for receiving a command signal from an AGV management system and sensor signals from a plurality of sensors;
a processor; and
a memory for storing a surrounding map and a plurality of programs to be executed by the processor, the plurality of programs comprising:
a task scheduling module, receiving the command signal from the interface, for converting the received command signal to generate an enabling signal corresponding to the received command signal;
a sensor fusion module, receiving the sensor signals and the enabling signal, for processing the received sensor signals according to the enabling signal, and generating an organized sensor data;
a mapping module, according to the enabling signal, for processing the organized sensor data and the surrounding map to generate an updated surrounding map, and storing the updated surrounding map into the memory; and
a localization module, according to the enabling signal, for processing the organized sensor data and the updated surrounding map to generate a location and pose signal.

2. The modular control system as claimed in claim 1, wherein the plurality of programs further comprise:
a navigation module, according to the enabling signal, for processing the location and pose signal and the updated surrounding map to generate a target path signal and motion control parameters; and
a robot coordination module, according to the enabling signal, for processing the target path signal and the motion control parameters to generate a robotic control signal for controlling the motion of the AGV.

3. The modular control system as claimed in claim 2, wherein the interface comprises:
a north bound interface for communicating with the AGV management system to receive the command signal and to transmit the updated surrounding map, the location and pose signal or the target path signal and the motion control parameters to the AGV management system.

4. The modular control system as claimed in claim 2, wherein the interface comprises:
a vehicle command interface transmitting the robotic control signal to motors or actuators of the AGV for controlling the motion of the AGV.

5. The modular control system as claimed in claim 2, wherein the interface comprises:
a material handling command interface transmitting the robotic control signal to motors or actuators of a robot attached to the AGV for controlling the motion or position of the robot.

6. The modular control system as claimed in claim 1, wherein the interface comprises:
a sensor interface for receiving the sensor signals from the plurality of sensors, including 2D or 3D vision sensor, LIDAR sensor, IMU sensor, or robot odometry sensor, wherein the sensor interface pre-processes the sensor signals by filtering out error or irrelevant sensor data and formatting sensor data into predefined format to generate pre-processed sensor signals.

7. The modular control system as claimed in claim 6, wherein the sensor fusion module, according to a pre-defined fusion policy or a dynamic fusion policy, synchronizes or aggregates by weightage the pre-processed sensor signals to generate the organized sensor data, and wherein the fusion policy comprises a parallel fusion policy or a central fusion policy.

8. The modular control system as claimed in claim 1, wherein the mapping module comprises:
a feature extraction module for extracting spatial features from the organized sensor data to generate extracted features;
a matching module for matching the extracted features with the surrounding map to obtain a matching result; and
a combination module, according to the extracted features, the location and pose signal and the matching result, to generate the updated surrounding map.

9. The modular control system as claimed in claim 2, wherein the plurality of programs further comprise:
a docking module, according to the enabling signal, for processing the organized sensor data and the surrounding map to generate a docking path signal and motion control parameters;
wherein the robot coordination module, according to the enabling signal, for processing the docking path signal and the motion control parameters to generate the robotic control signal for controlling the motion of the AGV.

10. The modular control system as claimed in claim 9, wherein the interface comprises:
a vehicle command interface transmitting the robotic control signal to motors or actuators of the AGV for controlling the motion of the AGV to a docket position.

11. The modular control system as claimed in claim 9, wherein the interface comprises:
a material handling command interface transmitting the robotic control signal to motors or actuators of a robot attached to the AGV for controlling the motion or position of the robot.

12. A method for controlling an automated guided vehicle (AGV), the method comprising steps of:
(a) providing a modular control system comprising an interface, a processor, and a memory, wherein the memory stores a surrounding map and a plurality of programs to be executed by the processor, and the plurality of programs comprises a task scheduling module, a sensor fusion module, a mapping module, and a localization module;
(b) the modular control system communicating through the interface to an AGV management system for receiving a command signal;
(c) the modular control system communicating through the interface to a plurality of sensors for receiving sensor signals;
(d) the task scheduling module receiving the command signal from the interface, and converting the received command signal to generate an enabling signal corresponding to the received command signal;
(e) the sensor fusion module receiving the sensor signals and the enabling signal, processing the received sensor signals according to the enabling signal, and generating an organized sensor data;
(f) the mapping module, according to the enabling signal, processing the organized sensor data and the surrounding map to generate an updated surrounding map, and storing the updated surrounding map into the memory; and
(g) the localization module, according to the enabling signal, processing the organized sensor data and the updated surrounding map to generate a location and pose signal.

13. The method as claimed in claim 12, wherein the plurality of programs further comprise a navigation module and a robot coordination module, and the method further comprises steps of:
the navigation module, according to the enabling signal, processing the location and pose signal and the updated surrounding map to generate a target path signal and motion control parameters; and
the robot coordination module, according to the enabling signal, processing the target path signal and the motion control parameters to generate a robotic control signal for controlling the motion of the AGV.

14. The method as claimed in claim 13, wherein the interface comprises a north bound interface, the modular control system communicates with the AGV management system through the north bound interface to receive the command signal in the step (b), and the method further comprises a step of:
the modular control system communicating with the AGV management system through the north bound interface to transmit the updated surrounding map, the location and pose signal or the target path signal to the AGV management system.

15. The method as claimed in claim 13, wherein the interface comprises a vehicle command interface, and the method further comprises a step of:
the modular control system transmitting the robotic control signal to motors or actuators of the AGV through the vehicle command interface for controlling the motion of the AGV.

16. The method as claimed in claim 13, wherein the interface comprises a material handling command interface, and the method further comprises a step of:
the modular control system transmitting the robotic control signal to motors or actuators of a robot attached into the AGV through the material handling command interface for controlling the motion or position of the robot.

17. The method as claimed in claim 12, wherein the interface comprises a sensor interface, the modular control system receives the sensor signals from the plurality of sensors, including 2D or 3D vision sensor, LIDAR sensor, IMU sensor, or robot odometry sensor, through the sensor interface, and the step (c) further comprises a step of:
the sensor interface pre-processing the sensor signals by filtering out error or irrelevant sensor data and formatting the sensor data into predefined format to generate pre-processed sensor signals.

18. The method as claimed in claim 17, further comprising a step of:
the sensor fusion module synchronizing or aggregating by weightage the pre-processed sensor signals to generate the organized sensor data according to a pre-defined fusion policy or a dynamic fusion policy, wherein the fusion policy comprises a parallel fusion policy or a central fusion policy.

19. The method as claimed in claim 12, wherein the mapping module comprises:
a feature extraction module for extracting spatial features from the organized sensor data to generate extracted features;
a matching module for matching the extracted features with the surrounding map to obtain a matching result; and
a combination module, according to the extracted features, the location and pose signal and the matching result, to generate the updated surrounding map.

20. The method as claimed in claim 13, wherein the plurality of programs further comprise a docking module, and the method further comprises steps of:
the docking module, according to the enabling signal, processing the organized sensor data and the surrounding map to generate a docking path signal and motion control parameters; and
the robot coordination module, according to the enabling signal, processing the docking path signal and the motion control parameters to generate the robotic control signal for controlling the motion of the AGV.
